(19) United States
(12) Patent Application Publication
(10) Pub. No.: US 2012/0044675 A1
(43) Pub. Date: Feb. 23, 2012

(54) Elongated LED Lamp

(75) Inventors: Roger F. Buelow, Gate Mills, OH (US); Laszlo A. Takacs, Lakewood, OH (US)

(73) Assignee: ENERGY FOCUS, INC., Solon, OH (US)

(21) Appl. No.: 13/216,236

(22) Filed: Aug. 23, 2011

Related U.S. Application Data
(60) Provisional application No. 61/375,937, filed on Aug. 23, 2010.

(51) Int. Cl. F21V 7/00; F21V 21/00

(52) U.S. Cl. 362/217.05; 362/217.01

(57) ABSTRACT

An elongated LED lamp includes an elongated side-light distribution arrangement least three sequentially arranged side-light distribution portions; a plurality of LED light sources respectively associated with said portions by having one LED light source primarily illuminating a respective portion, via a light coupling means, when the central axes of light emission from each of the LED light sources are not aligned with each other and by having one or a spaced pair of LED light sources, each located at an end of the portion, primarily illuminating a respective portion, via a light coupling means, when the associated LED light sources have central axes of light transmission aligned with each other; and each respective light coupling means transforms at least 15% of received light into an appropriate angular distribution needed for total internal reflection within an associated side-light distribution portion.

### CROSS-REFERENCE TO RELATED APPLICATIONS

This application claims priority to U.S. Provisional Patent Application No. 61/375,937 filed on Aug. 23, 2010, the disclosure of which is fully incorporated herein by reference.

### FIELD OF THE INVENTION

The present invention relates to elongated LED lamps that may replace elongated fluorescent lamps.

### BACKGROUND OF THE INVENTION

Elongated and typically linear lighting is used in various ways, ranging from lighting products in a vending machine or a refrigerated showcase in a supermarket, to lighting surfaces of a desk or under a cupboard. Traditionally, linear illumination devices include cold cathode tubes, neon tubes and fluorescent tubes. Fluorescent lighting devices have been generally desired by most businesses because of their electrical efficiency and their ability to provide uniform lighting. However, fluorescent tubes require high voltages and power, resulting in power usage of several tens of watts per meter. Such high voltages require additional electrical insulation of the fluorescent tube and extra care while handling the tubes. Repairs of fluorescent lighting devices can be costly for both parts and labor. Moreover, the lifetime of a fluorescent lamp is not very long, resulting in need to frequently change them. Sometimes, in a large supermarket, an employee is dedicated only to replacing burned-out fluorescent lamps in the display cases.

Recently, light emitting diodes (hereinafter “LEDs”), are being used as alternative forms of lighting. LEDs provide many advantages in lighting. They require less energy than a fluorescent lamp. They also do not produce any significant amount of infrared light in their light beam as a byproduct of their operation. However, many available LED lamps suffer from various drawbacks. For instance, when the number of LEDs required to achieve adequate illumination is reached in many available elongated LED lamps, the illumination creates a pixilated look and multi-shadowing on an illuminated surface. Also, the heat that is generated by the LEDs must be conducted away from the LEDs to ensure proper functioning of the LEDs.

Another problem with some prior art LED lighting fixtures is that the fixtures often overheat. It is necessary to provide for the LED lighting fixtures to dissipate its waste heat into the surrounding structure of the lamp. If such provisions are inadequate, the LED will overheat and undergo irreversible damage, which shortens the LED's useful life. In many prior art arrangements, all the heat is concentrated at the site of the LED. It is therefore desirable to reduce the local heat load of each LED to increase its useful life and/or reduce the size of the associated cooling structures.

There is a need for an elongated LED lamp that can replace fluorescent tubes, while avoiding the pixelated look and multi-shadowing on an illuminated surface present in some LED lamps.

### SUMMARY OF THE INVENTION

In one preferred example, an elongated LED lamp, comprises: an elongated side-light distribution arrangement comprising at least three sequentially arranged side-light distribution portions, a plurality of LED light sources respectively associated with said portions by having one LED light source primarily illuminating a respective portion, via a light coupling means, when the central axes of light emission from each of the LED light sources are not aligned with each other and by having one or a spaced pair of LED light sources, each located at an end of the portion, primarily illuminating a respective portion, via a light coupling means, when the associated LED light sources have central axes of light transmission aligned with each other; and each respective light coupling means transforms at least 15% of received light into an appropriate angular distribution needed for total internal reflection within an associated side-light distribution portion.

Beneficially, the foregoing elongated LED lamp can replace fluorescent tubes, while avoiding the pixelated look and multi-shadowing on an illuminated surface present in some LED lamps.

### BRIEF DESCRIPTION OF THE DRAWINGS

Other advantages and features of the invention will become apparent from reading the detailed description of the invention below in conjunction with the drawing figures, in which:

FIGS. 1A and 1C are respective top and a side views of a prior art lighting fixture showing LEDs located throughout the fixture.

FIG. 1C is a cross sectional view of a prior art lighting fixture showing LED's located throughout the side-light distribution member.

FIG. 2 is a side plan view of an exemplary elongated LED lamp.

FIG. 3 is a side plan view of another exemplary elongated LED lamp.

FIG. 4 is a side plan view of still another exemplary elongated LED lamp showing respective pairs of a LED light source and a coupling means.

FIG. 5 is a cross sectional view of the LED lamp of FIG. 4, taken at arrows 5, 5 in FIG. 4.

FIG. 6 is a side plan view of another exemplary elongated LED lamp.

FIG. 7 is a cross sectional view of the LED lamp of FIG. 6, taken at arrows 7, 7 in FIG. 6.

FIG. 8 is a perspective view of the LED lamp of FIG. 6.

FIG. 9 is a side-plan view of a further exemplary LED lamp.

FIG. 10 is a cross-sectional view of the LED lamp of FIG. 9, taken at arrows 10, 10 in FIG. 9.

FIG. 11 is a side plan view of another exemplary elongated LED lamp.

FIG. 12 is a cross-sectional view of the LED lamp of FIG. 11, taken at arrows 13, 13 in FIG. 11.

FIG. 13 is a side plan view of a further exemplary elongated LED lamp

FIG. 14 is a cross-sectional view of the LED lamp of FIG. 13, taken at arrows 14, 14 in FIG. 13.

FIG. 15 is a side plan view of a yet another exemplary elongated LED lamp.

FIG. 16 is a cross-sectional view of the LED lamp of FIG. 15, taken at arrows 16, 16 in FIG. 15.

### DETAILED DESCRIPTION OF THE INVENTION

The examples and drawings provided in the detailed description are merely examples, which should not be used to limit the scope of the claims in any claim construction or interpretation.

In the figures, various dimensions have been enlarged for clarity of explanation, such as a typical diameter of an LED lamp compared to its length.

### Led Light Source

A LED light source is defined herein as one or more LEDs provided with a single pair of power leads and, typically also, a single lens for conditioning light output, and includes a printed-circuit board on which an LED or LEDs are mounted, which may have a metal core to assist in heat removal.

### Prior LED Lighting Fixtures

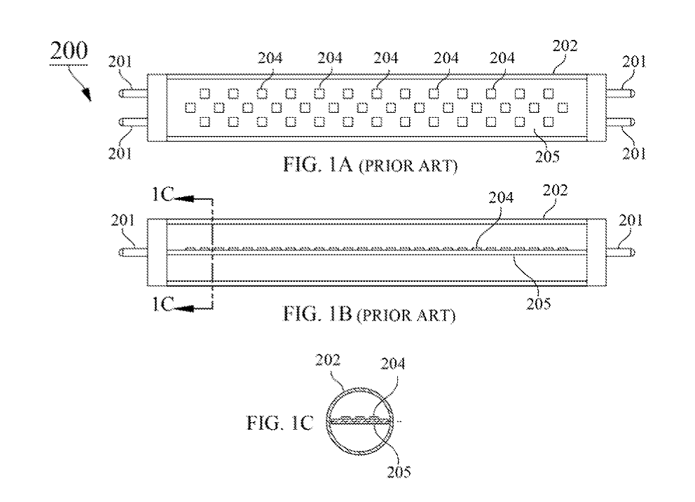

Prior art FIG. 1A shows a prior art elongated LED lamp 200 that replaces a fluorescent tube. Many small LED light sources 204 are arranged in an array along the length of the lamp 200. The array is on a circuit board (not shown) that is electronically connected to input power using electrode pins 201.

FIG. 1B shows a side view of the prior art lighting device of FIG. 1.

In FIG. 1C, a cross-sectional view of the prior art light device of FIG. 1A.

FIG. 1A shows the cylindrical nature of the replacement LED lamp 200 having a transparent sleeve 202 as well as the width of the heat sink 205 on which & LED light sources 204 are affixed. The heat sink 205 occupies approximately the full inner diameter of the transparent sleeve 202, and, as with the other heat sinks described herein, may comprise aluminum or other thermally conducting material.

### Central Path of TIR Light Propagation

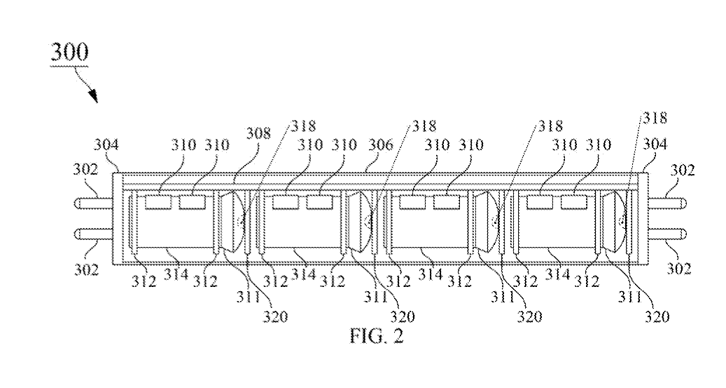

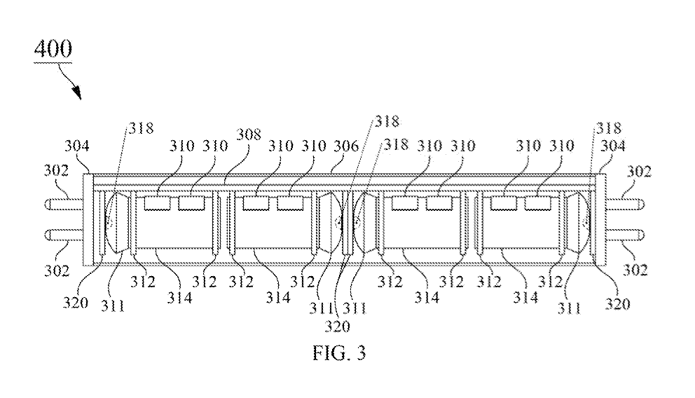

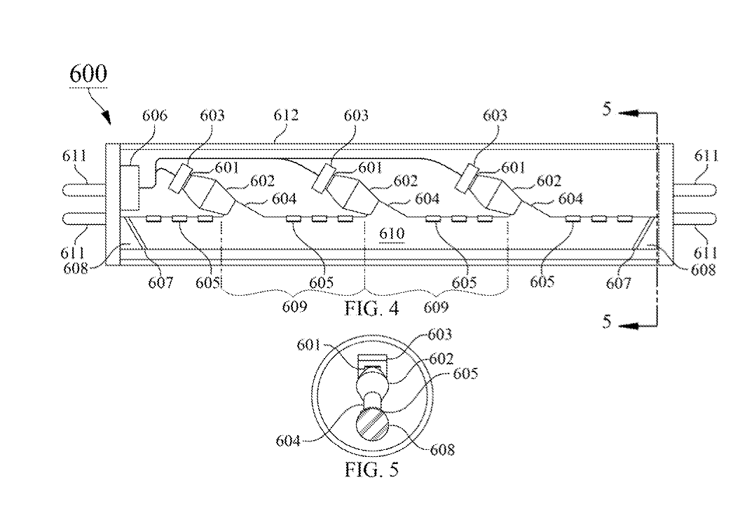

In one example, the central axis of light emission from a respective light coupling means that receives light from a respective LED light source, is oriented transverse to a central path of total internal reflection (TIR) light propagation through an associated side-light distribution portion, such as in FIG. 4, where TIR represents total internal reflection. In another example, a central axis of light emission from a respective LED light source is positioned so that a central axis of light emission is aligned with a central path of TIR light propagation through an associated side-light distribution portion, as would be apparent to a person of ordinary skill, as in FIGS. 2-3, for example.

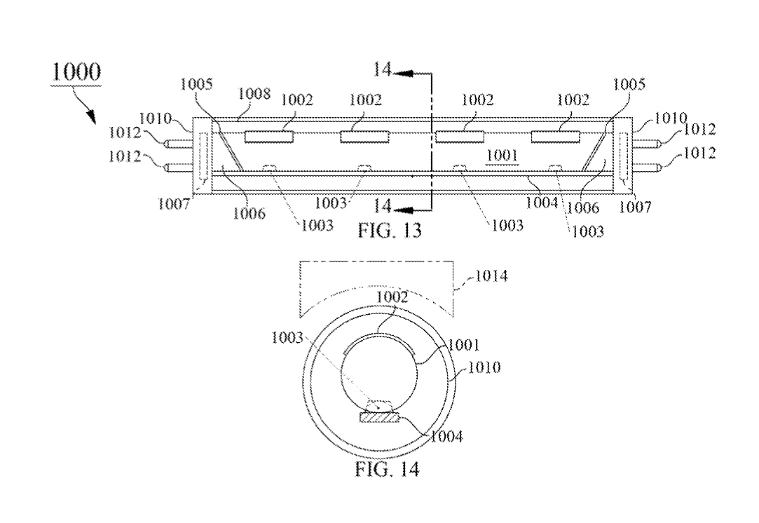

In one example, a respective light-extraction means is positioned in a direction opposite to an associated LED light source, as shown in FIG. 13, for example, with respect to a central path of light propagation along the length of a respective side-light distribution portion. This length would be the longest path, which would be linear length for a linear side-light arrangement. The length would be the longest non-continuous path that ends in a curve, for a curved arrangement.

The central path of light propagation of a respective side-light distribution portion is not shown in the respective FIGS. but would be readily apparent to a person of ordinary skill.

### Discontinuous Side-Light Distribution Portions

FIGS. 2 and 3 show elongated LED lamps 300 and 400, respectively, each of which contains an exemplary number of four side-light distribution portions 314. Lamps 300 and 400 can replicate a typical length of a fluorescent lamp tube of about four feet (122 cm), and preferably provide an equivalent amount of illumination.

Compared to an LED lamp having only one LED at one end or LEDs at both ends, the LED lamps 300 and 400 have LED light sources 318 whose area is reduced proportionately. Based on the law of Etendue, as the area of the light source is reduced, the diameter of the light coupling means and the side-light distribution arrangement becomes proportionately reduced to maintain the angular distribution of light propagating through the system.

In the LED lamp of FIG. 2, each of LED light sources 318 supplies light to an associated light coupling means 311; “light coupling means” are described in more detail below. Each LED light source 318 is supported on an associated heat sink 320. Each light coupling means 311 couples light into an associated side-light distribution portion 314, which may be affixed to a support 308 with brackets 312. Light-extraction means 310 are provided on side-light distribution portions 314 for extracting light from the side of the lamp 300. “Light-extraction means” are described in more detail below

The LED lamp 300 of FIG. 2 has end plates 304 that support electrode pins 302. A transparent protective sleeve 306 protects the side-light distribution portions 314 and associated parts shown within the sleeve.

The elongated LED lamp 400 of FIG. 3 contains like-numbered parts as in lamp 300 of FIG. 2, whose description with regard to FIG. 3 is thus omitted. However, the orientations of the side-light distribution portions 314 in relation to the LED light sources 318, for instance, differ as between FIGS. 2 and 3. For instance, in the center of the LED lamp 400 of FIG. 3, two LED light sources 318 are positioned adjacent to each other, with each having a respective heat sink 320, an arrangement not present in LED lamp 300 of FIG. 2.

Advantageously, the amount of materials and the weight of the LED lamps 300 and 400 of FIGS. 2 and 3 can be reduced by a factor of four over a prior art configuration having a single LED light source for a single side-light distribution portion while still delivering an equivalent amount of illumination. The thermal load on each LED light source 318 in this case can be reduced by a factor of four. In another embodiment, the number of side-light distribution portions is greater than the four shown in FIGS. 2 and 3. For instance, up to 10 or more side-light distribution portions may be used, with corresponding gains in optical and thermal requirements.

In between each side-light distribution portion 314 of the embodiments of FIGS. 2 and 3, there may be a small area of darkness because the side-light distribution portions 314 and LED light sources 318 of adjacent fragments cannot overlap in space. Sometimes, the dark spaces are desirable as a way to accent the light and show decorative marks along the length of the lamps. If these are not desired, then a different embodiment of the claimed LED lamp, as shown in FIG. 4, for example, will minimize or eliminate the dark areas.

FIGS. 4 and 5 show elongated LED lamp 600 having LED light sources 601 whose central axes of light emission pass into associated light coupling means 602 in such a way that the central axes are not aligned with each other, and are instead oriented transverse to a central path of TIR light propagation though side-light distribution arrangement 610. This contrasts with the light sources in FIGS. 2 and 3, for instance, in which the central axes of light transmission are aligned with each other.

A respective light coupling means 602 couples received light from each LED light source 601, which is supported on a heat sink 603. Each side-light distribution portion 609 of the side-light distribution arrangement 610 is primary illuminated by a respective pair of LED light source 601 and light coupling means 602 connected thereto via a respective connecting portion 604. Each side-light distribution portion 609 can receive light from an associated LED light source 601 directly or by TIR light propagation within a light coupling means 602 and associated connecting portion 604. The connecting portions 604 may not maintain the angular distribution of light received from the light coupling means 602.

Light is extracted from each of the side-light distribution portions 609 by respective light-extraction means 605. Residual light that is not extracted from the side-light distribution arrangement 610 on a first pass through the arrangement can be reflected back into the arrangement by mirrors 607, which are supported by support structures 608.

Each LED light source 601 is connected by wires to a power-regulating circuit 606, with such wires shown diagrammatically in FIG. 4. Power-regulating circuit 606, shown diagrammatically, converts AC power from electrodes (not shown) in a fluorescent lighting fixture, which engage the left-shown electrode pins 611, to DC power with a preferably constant DC current. The power-regulating circuit 606 is preferably physically placed between the left-shown electrode pins 611 and the LED light source 601. In addition, a transparent protective cover 612, connected to end plates 611 extends along the length of the LED lamp 600.

The connecting portion 604 is constructed to keep the light internal to itself through the use of TIR. The connecting portions 604 are in optical contact with the side-light distribution portions 609 so no light is lost as light moves from the connecting portion 604 to the side-light distribution portion 609. “Optical contact” occurs when two surfaces are in optical contact, and light traveling from one surface to the next surface does not experience a reflection as it leaves one surface and enters the next surface. Either the medium through which the light passes is the same or has substantially the same refractive index. Ideally, the connecting portion 604 is constructed from the same material as the light coupling means 602 and the side-light distribution portion 609.

In the embodiment of FIGS. 4 and 5, the amount of illumination emitted by the side-light distribution portions 609 may be increased by projecting more light into the side-light distribution portions without increasing their diameter, provided that no one light source 601 and light coupling means 602 pair violates the constraints of the law of Etendue. One advantage of this configuration is that the small dark areas, as present in the embodiments of FIGS. 2 and 3 are eliminated.

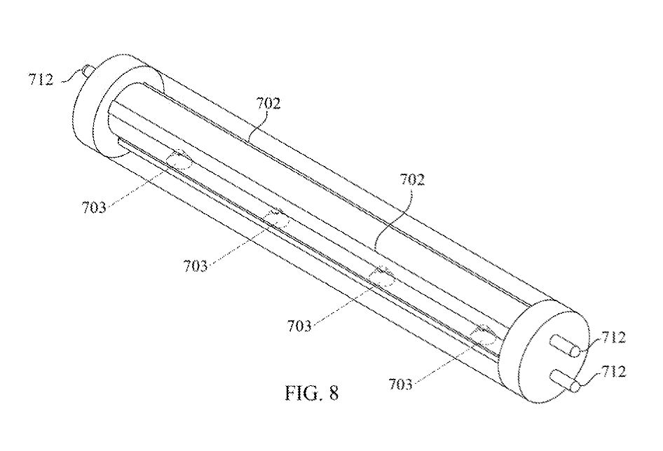

In yet another embodiment of the claimed invention, distributing the total LED light sources along the length of a side-light distribution arrangement can provide thermal benefits since there are separate sites over which to distribute the fixed thermal load. FIGS. 7-16 show such embodiments.

### Continuous Side-Light Distribution Portions

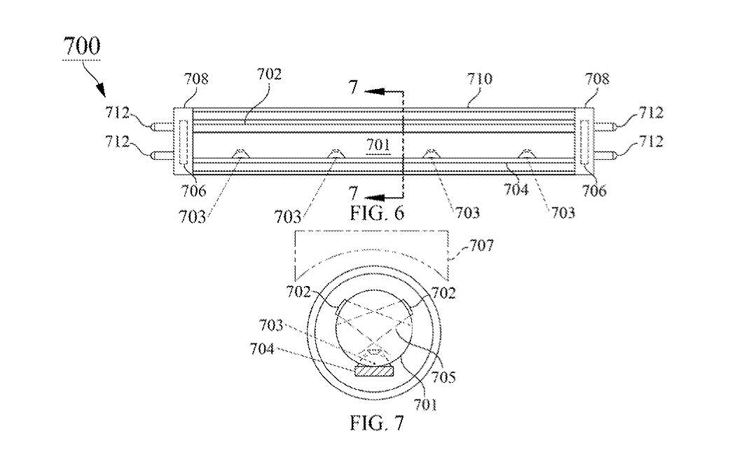

FIG. 7 shows an exemplary circular cross-section for the LED lamp 700 of FIGS. 6-8, but other cross-sectional shapes may be utilized. Light-extraction means 702 may consist of a Lambertian scattering material such as white paint or a specular reflecting material such as a metallic material or coating. Further details of light-extraction means are described below. Light-extraction means 702 may run continuously along the length of the side-light distribution arrangement 701 or it may be segmented in various patterns depending on the desired illumination effect. Light-extraction means 702 direct light out of the side-light distribution arrangement 701 as shown by light rays 705. The LED light sources 703 can be mounted on a heat sink 704.

In FIGS. 6-8, the side-light distribution arrangement 701 can have the light-extraction means 702 running along its length. Each LED light source 703 is positioned in a direction transverse to the main path of TIR light propagation through the side-light distribution arrangement 701.

As best shown in FIG. 7, the LED light sources 703 can be received partially or completely within the side-light distribution arrangement 701. Preferably, the entire light-emitting surface of the LED light sources 703 is received within respective cavities in the side-light distribution arrangement 701. The side-light distribution arrangement 701 inherently performs some angular transformation of the light it receives, at least 15% of received light, to support TIR propagation through side-light distribution arrangement 701. This is due to an increase in area experienced by many light rays 705 travelling from the LED light sources 703 into the side-light distribution arrangement 701.

Each LED light source 703 may be mounted to a heat sink 704 for dissipating heat from the light source. The LED light source 703, in another instance, can be optionally connected to a different mounting structure.

The light from the LED light sources 703 is guided towards the light-extraction means 702 by the inherent light coupling means mentioned above. In this example shown in FIG. 7, the side-light distribution arrangement 701 includes a plurality of portions, each associated with a respective LED light source 703 and which primarily receives it light from that light source.

The light-extraction means 702 distributes the illumination from the LED light sources 703 so as to be able to create an evenly distributed illumination. An exemplary spacing of the light-extraction means 702 can be best seen in FIG. 7, which shows that such means 702 exists at two locations spaced apart on the circumference of side-light distribution arrangement 701.

Optionally, a non-specular reflector 707 may be placed over the LED lamp 700 of FIG. 7 to capture and redirect light that might otherwise be lost. Such captured and redirected light may amount to about 30% of the light directed downwardly by light-extraction means 702.

The elongated LED lamp 700 of FIG. 7 includes electrode pins 712. One or more power-regulating circuits 706, shown diagrammatically, may be supported on end plates 708. In addition, a transparent protective cover 710, connected to end plates 708 extends along the length of the LED lamp 700.

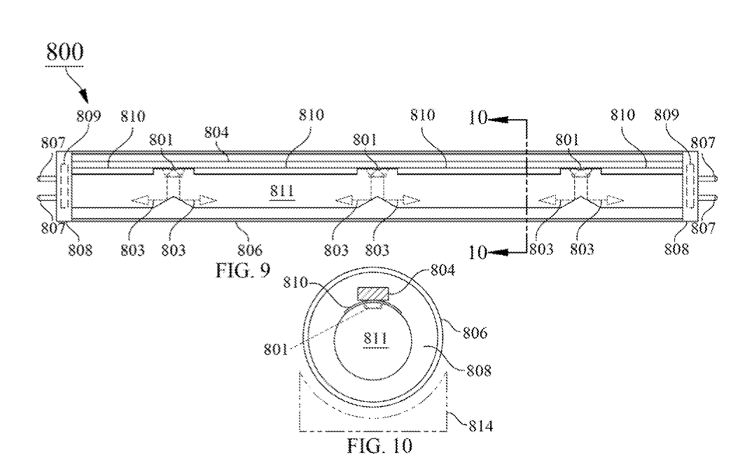

In LED light source 800 of FIGS. 9 and 10, LED light sources 801 transmit light 803 to associated notches 805 The LED lamp 800 includes a transparent protective cover 806, electrode pins 807, power-regulating circuits 809, and end plates 808. Light rays 803 are propagated in a sideways direction, as shown by arrows 803, using a specular reflective surface 802. The light-extraction means 810 can be positioned on the same side as LED light source 801. In one example, an associated LED light source is positioned within a circumference of the light-extraction means taken about a central axis of light transmission from a respective light coupling means oriented transverse to a central path of TIR light propagation through an associated side-light distribution portion.

In this embodiment, the reflective surfaces 802 causes a large amount of the light emitted by the LED light sources 801 to be sent sideways in the side-light distribution arrangement 811 below the angle required for TIR propagation along the length of the arrangement 811. Similar to LED lamp 700 of FIGS. 6-8, LED light source 801 may be mounted on a heat sink 804. Specular redirection of light may be achieved by total internal reflection or the use of a reflective surface. A non-specular reflector 814 may optionally be utilized to capture and redirect light passing through light-extraction means, for instance, that otherwise could be wasted.

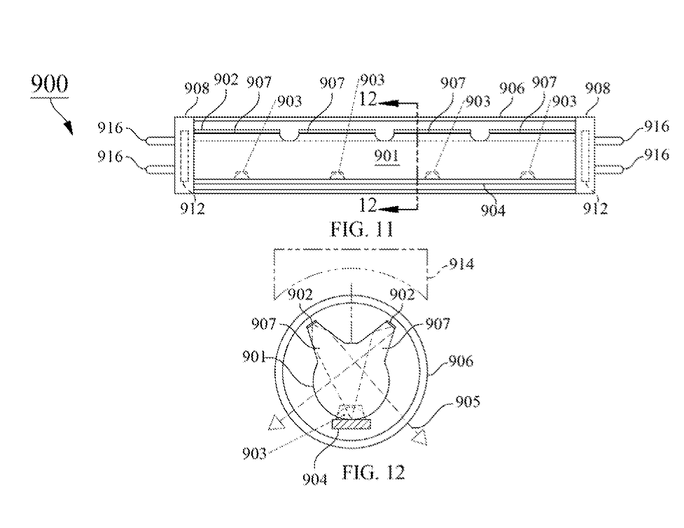

FIGS. 11 and 12 show another embodiment where the side-light distribution arrangement 901 includes protrusions 907 designed to help guide light from the LED light sources 903 to reach light-extraction means 902. Light-extraction means can be any of those described below, under Light-Extraction Means, and could alternatively be a reflective material. Each pair of protrusions 907 extend radially outward from a side-distribution arrangement 901 with a respect to a central path of TIR light propagation through the arrangement. As used herein, a side-light distribution arrangement comprises at least three side-light distribution portions, each of which is primarily illuminated by a single LED light source.

The protrusions 907 could be, but are not necessarily made to closely replicate non-imaging optical coupling means such as non-imaging light-coupling means described in detail below. The protrusions 907 also provide a level of collecting and directing of the light reflected or scattered from the light-extraction means 902 in a directed manner, as indicated by arrows 905. The protrusions 907 may run continuously along the length of the side-light distribution portion. Alternatively, the protrusions 907 may, as indicated by phantom-line areas 910 that would be absent and cause the protrusions to constitute a plurality of discrete protrusions along the length of the side-light distribution arrangement 901.

In one example, the protrusions 902 extend continuously along a majority of the length of the side-light distribution arrangement 901. In a more preferred example, the protrusions extend continuously along at least 80 percent of the length of the side-light distribution arrangement 901. Alternatively, the protrusions can extend along the length of the side-distribution arrangement in discrete portions.

As shown in FIG. 12 by light rays 905, the light from LED light sources 903 will enter the protrusions 902. The light-extraction means 902, located along the top of the conical protrusion of the arrangement 901, will direct the light back into the arrangement, creating an even illumination.

In FIG. 12, the LED light sources 903 may be mounted to metallic heat sinks 904. Light rays 905 generated by LED light source are transmitted to the protrusions 907 and strike the light-extraction means 902. The light rays 905 are then turned and directed out of the side-light distribution arrangement 901 because their angles now exceed the angle needed for TIR within the arrangement 901.

The elongated LED lamp 900 of FIGS. 11 and 12 include end plates 908 having power-regulating circuits 912 and electrode pins 916. In addition, a transparent protective cover 906 is included. A non-specular reflector 914 may optionally be utilized to capture and redirect light passing through light-extraction means, for instance, that otherwise could be wasted.

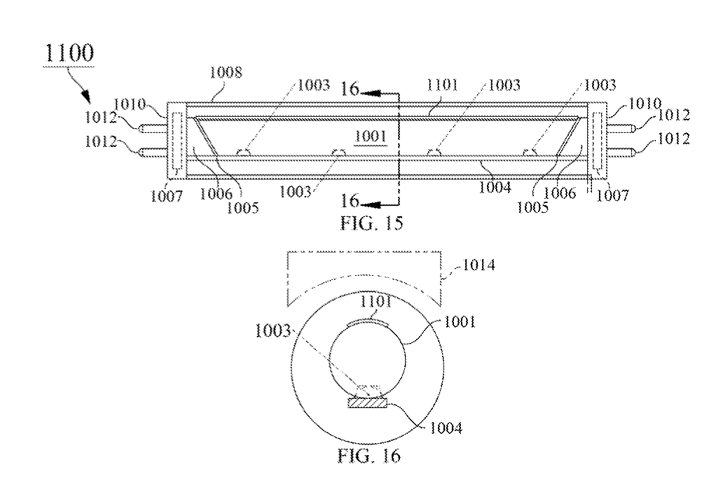

FIGS. 13 and 14 show an alternative elongated LED lamp 1000, wherein LED light sources 1003 are arranged as in the embodiment of FIGS. 12 and 13, but where the cross section of the side-light distribution arrangement 1001 is circular, as shown in FIG. 14. FIGS. 15 and 16 show a similar LED lamp 1100, but where light-extraction means 1101 is continuous along most of the length of the side-light distribution arrangement 1001.

In LED lamps 1000 and 1100, the light from light source 1003, at least partially received within a cavity as in prior embodiments, is directed by the light-extraction means 1002 (FIGS. 13-14) and 1101 (FIGS. 15 and 16) out the side of the receptive side-light distribution arrangements 1001. A non-specular reflector 1014 may be used to capture and redirect light passing through the light-extraction means 1002 or 1101, for instance, that would otherwise be lost.

In FIGS. 13 and 15, light-extraction means 1002 or 1101 are applied over the length of the LED lamp 1000 or 1100. The elongated LED lamps 1000 and 1100 may include specular mirrors 1005, transparent protective covers 1008, and end plates 1010 which includes a power-regulating circuit 1007, similar to those described above. A reflector 1014 may be optionally be utilized, as shown in FIG. 15.

In FIGS. 14 and 16, LED light sources 1003 are mounted on metallic heat sinks 1004. Light-extraction means 1101 is placed in a direction opposite to that of LED light source 1003. A non-specular reflector 1014 may be optionally utilized.

The elongated LED lamp includes mirrors 1005, end plates 1010, a power-regulating circuit 1007 and electrode pins 1012.

### Non-Imaging Light Coupling Means

A “non-imaging” light coupling means, as used herein, tolerates minor manufacturing imperfections while retaining substantially the full functionality of an ideally formed non-imaging coupling means.

Normally, the light coupling means only transforms light from the light source into the proper angular distribution required by the side-light distribution arrangement. The side-light distribution arrangement normally only transports light down its length (via total internal reflection), delivering the light to the end opposite the light source. Also, the light-extraction means only extracts light transverse to the length of the side-light distribution arrangement; it does not collect light from a light source or perform any angular transformation of the light.

Regarding the light coupling means, its interiorly-directed reflective surface is normally the primary device for receiving light from a light source. It then transmits that light toward a light-receiving portion of a side-light distribution arrangement, which is discussed in later paragraphs. This reflective surface is typically specular if the light coupling means is hollow, or of the TIR-type if the light coupling means is solid, where TIR means total internal reflection.

The rules of non-imaging optics govern the configuration of the light coupling means at least approximately. As known in the art, the rules of non-imaging optics are concerned with the optimal transfer of light radiation between a source and a target. In contrast to traditional imaging optics, non-imaging techniques do not attempt to form an image of the source; instead, an optimized optical system for radiative transfer from a source to a target is desired.

The two design problems that non-imaging optics solves better than imaging optics are as follows, First, (1) concentration—maximizing the amount of energy applied to the target (as in solar power, for instance, “collecting radiation emitted by high-energy particle collisions using the fewest number of photomultiplier tubes”). Second, (2) illumination—controlling the distribution of light, typically so it is “evenly” spread over some areas and completely blocked from other areas (as in automotive headlamps, LCD backlights, etc.).

Typical variables to be optimized at the target include the total radiant flux, the angular distribution of optical radiation, and the spatial distribution of optical radiation. These variables on the target side of the optical system often must be optimized while simultaneously considering the collection efficiency of the optical system at the source.

Typically, a light coupling means at least approximately governed by the rules of non-imaging optics has a profile that changes from the inlet end toward the outlet end to condition the angular distribution of light provided to a rod-shaped side-light distribution arrangement. That is, as light propagates through the light coupling means, its angular distribution changes. In addition, the interior surface of a solid light coupling means may be configured to aid in the conditioning of light provided to a rod-shaped light pipe.

This change in the angular distribution of light conditions the light for distribution by the side-light distribution arrangement. Three examples are as follows. First, (1) the light may be conditioned to reduce the angular distribution of light to be significantly below the numerical aperture or acceptance angle of a side-light distribution arrangement so that it propagates along the entire length of the side-light distribution arrangement and is distributed out the opposite end.

In a second example (2), the angular distribution of light leaving the light coupling means can be higher but closer, or even beyond, the numerical aperture (NA) of the side-light distribution arrangement. In this case, the light leaving the light coupling means with a higher angular distribution will see a greater number of interactions with the sides of the side-light distribution arrangement, thereby increasing the opportunity for distribution out the side of the side-light distribution arrangement over a shorter distance.

In a third example (3), the profile of the light coupling means changes so that the light leaving the light coupling means is not only conditioned to cause the angular distribution to be within an intended NA, but also is conditioned to cause the light to be uniformly distributed among a greater number of angles. In this case, at least approximately governed by the rules of non-imaging optics, the profile of the light coupling means will typically grow in size and then decrease as it approaches and reaches the side-light distribution arrangement. Because the resulting light is conditioned so that light is present at a multitude of angles, light with higher angles will have more interactions with the side of the side-light distribution arrangement and will be distributed over shorter distances, and light with lower angles will see fewer interactions so will be distributed over longer distances. The result may be a more uniform distribution out of the side-light distribution arrangement along its entirety.

With respect to the light coupling means, the coupling means can have an increasing cross-sectional area from a light coupling inlet end and a light coupling outlet end. The change in area for the light coupling means can be of a non-monotonic function, for example, a compound parabolic curve. The increase in cross-sectional area of the light coupler may follow the pattern disclosed in U.S. Pat. No. 6,219,480, the disclosure of which is incorporated herein by reference. More specifically, the cross-sectional area of the light coupling means increases in a continuous manner, where “continuous” means that the cross section at a point along an axial length transitions to a next point without any substantial discontinuities.

Alternatively, the cross-sectional area of the light coupling means can increase and decrease in a continuous manner, where “continuous” means that the cross section at a point along an axial length transitions to a next point without any substantial discontinuities.

In another example, the cross-sectional area of the light coupling means increases or decreases in a continuous manner, where “continuous” means that the cross section at a point along an axial length transitions to a next point without any substantial discontinuities. For example, a central path of light propagation occurs from an inlet end to an outlet end, where a cross-section increases from a first cross-sectional area to a maximum cross-sectional area and then decreases in cross-section to a final cross-sectional area larger than the first cross-sectional area.

### Side-Light Distribution Arrangement

A side-light distribution arrangement as used herein preferably comprises an elongated rod. By “elongated” it is meant being long in relation to width or diameter, for instance, where the “long” dimension can be both along a straight path or a curved path.

One end of the side-light distribution arrangement receives light from an associated light coupling means. The elongated rod has an elongated sidewall and light-extraction means along at least part of the elongated sidewall for extracting light through the sidewall and distributing said light to a target area. At least, the part of the side-light distribution arrangement having light-extraction means is preferably solid, although there may exist in the arrangement small voids caused by manufacturing processes, for instance, voids that have insubstantial impact on the side-light light-extraction and distribution properties of the side-light distribution arrangement.

A side-light distribution arrangement as used herein has a cross section along a main axis of light propagation through the pipe that is more round than flat. For example, the minimum cross-sectional dimension is preferably more than 50% of the maximum cross-sectional dimension. In a preferred embodiment, the cross-section of the side-light distribution arrangement is substantially circular.

Preferably, a side-light distribution arrangement is rigid, by which is meant that at 20 degrees Celsius the arrangement has a self-supporting shape such that the light pipe returns to its original or approximately original (e.g., linear or curved) shape after being bent along a main path of light propagation through the light pipe. However, if the side-light distribution arrangement is flexible, it is meant that the side-light distribution arrangement has a shape that will be bent to a shape that has a curvature when being bent along its longitudinal axis.

The preferred embodiment of the side-light distribution arrangement is one that includes a constant cross-sectional area, within manufacturing tolerances known to a person of ordinary skill. Such constant cross-sectional area is within a + or −5% deviation. In one example, a useful embodiment of the system may include a monotonically increasing cross-sectional area of the side-light distribution arrangement. The increasing cross-sectional area reduces the angular distribution of light passing through the light coupling means, so as to enable the light rays to propagate at higher angles while maintaining total internal reflection.

The decreasing cross-sectional area aids in extraction of light from the sides of the side-light distribution arrangement, because the angles of light effectively become steeper with respect to the covering surface of the side-light distribution arrangement.

The side-light distribution arrangement may have a nearly constant cross-sectional area. The term “nearly constant” cross-sectional area indicates a generally constant cross-sectional area with + or −5% deviation. The cross-sectional area of the side-light distribution arrangement may become “gradually larger” starting from the inlet end and moving towards the second end of the side-light distribution arrangement. Alternatively, the cross-sectional area of the side-light distribution arrangement may become “gradually smaller” starting from the inlet end and moving towards the second end of the side-light distribution arrangement. When defining “gradually larger” or “gradually smaller,” the cross-sectional area increases or decreases in a continuous manner, where “continuous” means that the cross section at a point along an axial length transitions to a next point without any substantial discontinuities, as disclosed in the foregoing '480 patent. The change in cross-sectional area is of a monotonic function.

### Light-Extraction Means

Now specific examples of the light-extraction means will be discussed. Light-extraction means may be of various types whose selection will be routine to those of ordinary skill in the art. For instance, three types of light-scattering means are disclosed in U.S. Pat. No. 7,163,326, entitled “Efficient Side-light Luminaire with Directional Side-Light-Extraction,” assigned to Energy Focus, Inc. of Solon, Ohio. In brief, these three types are (1) discontinuities on the surface of a side-light distribution arrangement, (2) a layer of paint on the surface of a side-light distribution arrangement, and (3) a vinyl sticker applied to the surface of a side-light distribution arrangement.

In more detail, (1) discontinuities on the surface of a side-light distribution arrangement may be formed, for instance, by creating a textured pattern on the side-light distribution arrangement surface by molding, by roughening the side-light distribution arrangement surface with chemical etchant, or by making one or more notches in the side of a side-light distribution arrangement.

In another example, the light-extraction means may comprise a layer of paint exhibiting Lambertian-scattering and having a binder with a refractive index about the same as, or greater than that of, the core. Suitable light-extraction particles are added to the paint, such as titanium dioxide or many other materials as will be apparent to those of ordinary skill in the art. Preferably, the paint is an organic solvent-based paint.

In yet another example, the light-extraction means may comprise vinyl sticker material in a desired shape applied to the surface of the side-light distribution arrangement. Appropriate vinyl stickers have been supplied by Avery Graphics, a division of Avery Dennison of Pasadena, Calif. The film is an adhesive white vinyl film of 0.146 mm, typically used for backlit signs.

In another example, the light-extraction means may be continuous, intermittent, or both, along the length of a side-light distribution arrangement, for instance. An intermittent pattern is shown in the above-mentioned U.S. Pat. No. 7,163,326 in FIG. 15A, for instance. To assure that the light-extraction means appears as continuous from the point of view of the observer in a target area to be illuminated, the target area should be spaced from the side-light distribution arrangement in the following manner: the spacing should be at least five times the length of the largest gaps between adjacent portions of paint or other light-extraction means along the main path of TIR light propagation through the side-light distribution arrangement.

Additionally, the foregoing light-extraction patterns may be of the specular type, scattering type, or a combination of both. Generally, a scattering extractor pattern for light on an elongated side-light distribution arrangement tends to provide light onto a target area, along the length of the side-light distribution arrangement, with a moderate degree of directional control over the light in the length direction. In the direction orthogonal to the length, the scattering extractor pattern density and the cross sectional shape of the elongated side-light distribution arrangement provide a smooth target distribution that is free of localized spatial structure but still provides good directional control. Scattering extractor patterns are relatively insensitive to fabrication errors.

In contrast, as used herein, a specular extraction pattern can provide light along the length of a side-light distribution arrangement with more localized control than can a scattering extraction pattern.

The following is a list of reference numerals and associated parts as used in this specification and drawings:

| Reference Numeral | Part |
|---|---|
| 200 | LED lamp |
| 201 | Electrode Pins |
| 202 | Sleeve |
| 204 | LED light source |
| 205 | Heat sink |
| 300 | LED lamp |
| 302 | Electrode Pins |
| 304 | End plates |
| 306 | Protective sleeve |
| 308 | Support |
| 310 | Light-extraction means |
| 311 | Light coupling means |
| 312 | Bracket |
| 314 | Side-light distribution portion |
| 318 | LED light source |
| 320 | Heat sink |
| 400 | LED lamp |
| 600 | LED lamp |
| 601 | LED light source |
| 602 | Light coupling means |
| 603 | Heat sink |
| 604 | Connecting portion |
| 605 | Light-extraction means |
| 606 | Power-Regulating Circuit |
| 607 | Mirror |
| 608 | Support Structure |
| 609 | Side-light distribution portion |
| 610 | Side-light distribution arrangement |
| 611 | Electrode pins |
| 612 | Protective cover |
| 700 | LED lamp |
| 701 | Side-light distribution arrangement |
| 702 | Light-extraction means |
| 703 | LED light source |
| 704 | Heat sink |
| 705 | Light rays |
| 706 | Power-regulating Circuit |
| 707 | Reflector |
| 708 | End plate |
| 710 | Protective cover |
| 712 | Electrode Pins |
| 800 | LED lamp |
| 801 | LED light source |
| 802 | Reflective surface |
| 803 | Light ray |
| 804 | Heat sink |
| 805 | Notches |
| 806 | Protective cover |
| 807 | Electrode Pins |
| 808 | End Pins |
| 809 | Power-regulating Circuit |
| 810 | Light-extraction means |
| 811 | Side-light distribution arrangement |
| 814 | Reflector |
| 900 | LED lamp |
| 901 | Side-light distribution arrangement |
| 902 | Light-extraction means |
| 903 | LED light source |
| 904 | Heat sink |
| 905 | Light ray |
| 906 | Protective cover |
| 907 | Protrusions |
| 908 | End plate |
| 910 | Phantom-line area |
| 912 | Power-regulating Circuit |
| 916 | Electrode Pins |
| 1000 | LED lamp |
| 1001 | Side-light distribution arrangement |
| 1002 | Light-extraction means |
| 1003 | LED light source |
| 1004 | Heat sink |
| 1005 | Mirror |
| 1006 | Protective cover |
| 1007 | Power-regulating circuit |
| 1008 | Protective cover |
| 1010 | Power-regulating Circuit |
| 1012 | Electrode Pins |
| 1100 | LED lamp |
| 1101 | Light-extraction means |

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

2-20. (canceled)

20. An elongated LED lamp, comprising:
a) an elongated side-light distribution arrangement comprising at least three sequentially arranged side-light distribution portions, each of said portions respectively having light-extraction means for extracting light from a side of the side-light distribution arrangement;
b) a plurality of LED light sources respectively associated with said portions by having one LED light source primarily illuminating a respective portion, via a light coupling means, when the central axes of light emission from each of the LED light sources are not aligned with each other and by having one or a spaced pair of LED light sources, each located at an end of the portion, primarily illuminating a respective portion, via a light coupling means, when the associated LED light sources have central axes of light transmission aligned with each other; and
c) each respective light coupling means transforming at least 15% of received light into an appropriate angular distribution needed for total internal reflection within an associated side-light distribution portion.

21. The LED lamp of claim 20, wherein the LED light sources are spaced in a manner to achieve uniform light distribution along a length of the side-light distribution arrangement to within 20 percent of an average value of illumination along said length.

22. The LED lamp of claim 20, wherein a central axis of light emission from each light coupling means is oriented transverse to a central path of TIR light propagation through an associated side-light distribution portion.

23. The LED lamp of claim 22, wherein each light coupling means is connected to a respective side-light distribution portion by a respective connecting portion that transmits light from an associated light coupling means to an associated side-light distribution portion.

24. The LED lamp of claim 23, wherein the plurality of sequentially arranged side-light distribution portions are continuous.

25. The LED lamp of claim 22, wherein:
a) each light coupling means comprises an intrinsic section of an associated side-light distribution portion designed for TIR propagation along said central path;
b) said light coupling means relying on an inherent increase in average area experienced by light passing transversely towards said central path for said transforming at least 15% of received light received.

26. The LED lamp of claim 25, wherein each of the side-light distribution portions includes a cavity for receiving, at least partially, a light-emitting portion of an associated LED light source.

27. The LED light source of claim 26, further comprising a non-specular reflector oriented to capture and redirect light passing through said light-extraction means.

28. The LED lamp of claim 26, wherein each light-extraction means is positioned in a direction opposite to the associated LED light source with respect to said central path.

29. The LED lamp of claim 28, wherein the light-extraction means is formed of a continuous stripe of material or discontinuities of surface of the side-light distribution arrangement along said central path from at least the position of LED light source to an adjacent LED light source.

30. The LED lamp of claim 28, wherein the light-extraction means is formed of intermittent material or intermittent discontinuities of surface of the side-light distribution arrangement along said central path.

31. The LED lamp of claim 20, wherein:
a) the side-light distribution portions are physically separate from each other; and
b) each LED light source is positioned so that a central axis of light emission therefrom is aligned with a central path of TIR light propagation through an associated side-light distribution portion.

32. The LED lamp of claim 26, wherein:
a) the side-light distribution arrangement comprises continuously connected side-light distribution portions; and
b) respective notches are formed in the surface of the side-light distribution arrangement, wherein each notch is positioned on an opposite surface of the side-light distribution arrangement from said light sources relative to said central path from an associated LED light source, and each notch is configured to receive light from said associated LED light source and direct said light in both directions along the length of said arrangement.

33. The LED lamp of claim 32, wherein the notch is V-shaped.

34. The LED lamp of claim 32, wherein the light-extraction means is positioned on the same side of the side-light distribution portions as an associated LED light source relative to said central path.

35. The LED lamp of claim 34, wherein said associated LED light source is positioned within a circumference of the light-extraction means taken about said central axis.

36. The LED lamp of claim 25, wherein:
a) said side-light distribution portions are continuously connected together;
b) the side-light distribution portions include a pair of protrusions extending radially outward from said side-light distribution portions at the same location along said central path;
c) an extremity of each protrusion having a light-extraction means;
d) the protrusions being arranged about said central path so as to each receive a majority of the light from an associated LED light source;
e) extraction of light from the side-light distribution portion occurring by light being received from an associated LED light source by said light-extraction means at the extremity of each protrusion and being redirected back though the protrusion before exiting the side-light distribution portion; and
f) each protrusion being shaped to enhance collection of light from an associated LED light source at an associated light-extraction means compared to a side-light distribution portion without said protrusions.

37. The LED lamp of claim 36, wherein the protrusions are arranged about said central path so as to receive at least 80% of the light from an associated LED light source.

38. The LED lamp of claim 36, wherein each protrusion is shaped so as to guide light, which is redirected internally within an associated side-light distribution portion, in such a way as to exit the side of the foregoing side-light distribution portion in a more directed manner than a side-light distribution portion without said protrusions.

39. The LED lamp of claim 36, wherein said protrusions extend continuously along at least 80 percent of the length of the side-light distribution arrangement.

40. The LED lamp of claim 36, wherein said protrusions extend along the length of the side-light distribution arrangement in separate, discrete portions.
